(19) United States
(12) Patent Application Publication
(10) Pub. No.: US 2022/0333479 A1
(43) Pub. Date: Oct. 20, 2022

(54) WELL PLACEMENT SYSTEMS AND METHODS TO DETERMINE WELL PLACEMENT

(71) Applicant: Halliburton Energy Services, Inc., Houston, TX (US)

(72) Inventors: Vladimir Y. KISELEV, Conroe, TX (US); Jeremy J. COMBS, The Woodlands, TX (US); Junpu ZHAO, Humble, TX (US)

(73) Assignee: Halliburton Energy Services, Inc.

(21) Appl. No.: 17/230,845

(22) Filed: Apr. 14, 2021

(51) Int. Cl. E21B 47/022; E21B 7/04; E21B 44/00

(52) U.S. Cl. CPC E21B 47/022; E21B 7/04; E21B 44/00; E21B 2200/20

(57) ABSTRACT

Well placement systems and methods to determine well placements are disclosed. A method to determine well placement includes generating a trajectory of a target well of a wellsite. The method also includes plotting the trajectory of the target well. The method further includes determining whether an offset well has been drilled at the wellsite. In response to a determination that the offset well has been drilled at the wellsite, the method further includes determining a well path of the offset well and one or more parameters of the offset well, and plotting the well path of the offset well, wherein the well path of the offset well and the trajectory of the target well are superimposed over each other.

### BACKGROUND

The present disclosure relates generally to well placement systems and methods to determine well placements.

Hydrocarbon wells are constructed to extract oil, gas, and/or byproducts from underground reservoirs that are disposed in subterranean or subsea formations. The placement of a hydrocarbon well is sometimes pre-planned before construction of the wellbore. Moreover, properties of one or more formations that the well traverses through are sometimes taken into account when determining where to place the well, the type of the well, the depth of the well, and other properties of the well.

### BRIEF DESCRIPTION OF THE DRAWINGS

Illustrative embodiments of the present disclosure are described in detail below with reference to the attached drawing figures, which are incorporated by reference herein, and wherein:

FIG. 1 is a schematic, side view of a drilling environment in which a well placement system is deployed;

FIG. 2A is a plan view of a trajectory of a target well and well paths of two offset wells;

FIG. 2B is a plot of the trajectory of the target well of FIG. 2A;

FIG. 2C is a plot of the trajectory of the target well and a first offset well superimposed over each other;

FIG. 2D is a plot of the trajectory of the target well and a second offset well superimposed over each other;

FIG. 2E is a plot of the trajectory of the target well, the well path of the first offset well illustrated in FIG. 2C, and the well path of the second offset well illustrated in FIG. 2D superimposed over each other;

FIG. 2F is another plot of the trajectory of the target well, the well path of the first offset well illustrated in FIG. 2C, and the well path of the second offset well illustrated in FIG. 2D superimposed over each other;

FIG. 3A is a plan view of a trajectory of a target well, and well paths of another well and two offset wells of a nearby wellsite;

FIG. 3B is a plot of the trajectory of the target well of FIG. 3A;

FIG. 3C is a plot of the trajectory of the target well, the well path of the first offset well of the nearby wellsite, and the well path of the second offset well of the nearby wellsite superimposed over each other;

FIG. 4 is a plan view of a trajectory of a target well and a well path of an offset well having an azimuth that is not within a threshold range of an azimuth of the target well;

FIG. 5 is a block diagram of a well placement system; and

FIG. 6 is a flow chart of a process to determine well placement.

The illustrated figures are only exemplary and are not intended to assert or imply any limitation with regard to the environment, architecture, design, or process in which different embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

The present disclosure relates to well placement systems and methods to determine well placements. The well placement system obtains wellsite data of one or more wellsites. As referred to herein, wellsite data refers to any data regarding placement and construction of a wellsite, including, but not limited to, placement and well paths of one or more existing offset wells at the wellsite, azimuths of the one or more offset wells, trajectories of yet-to-be constructed wells at the wellsite, properties of downhole formations of the wellsite, as well as other data related to the wellsite and existing and future wells of the wellsite.

The well placement system generates a trajectory of a target well of the wellsite and plots a trajectory of the well. The well placement system also determines whether an offset well has been drilled at the wellsite. In response to a determination that an offset well has been drilled at the wellsite, the well placement system determines a well path of the offset well and one or more parameters of the offset well, and plots a well path of the offset well, wherein the well path of the offset well and the trajectory of the target well are superimposed over each other. As referred to herein, an offset well refers to any well that is used as a reference to a target well. Examples of one or more parameters of an offset well include, but are not limited to, the azimuth of the offset well, the dip angle of the offset well, the curvature of the offset well, formation properties of the formation surrounding the offset well, the length of the offset well, the distance of the offset well relative to the target well, as well as other quantifiable characteristics of the offset well. In some embodiments, the offset well and the target well are at the same wellsite. In some embodiments, the offset well is located at a nearby wellsite, or a wellsite that is within a threshold distance from the target well. Further, as referred to herein, a target well is a proposed well that has yet to be drilled or is currently being drilled.

In some embodiments, the well placement system also determines whether a second offset well has been drilled at the wellsite. In one or more of such embodiments, the well placement system, in response to a determination that the second offset well has been drilled at the wellsite, determines a well path of the second offset well and one or more parameters of the offset well, and plots the well path of the second offset well, where the trajectory of the target well, the well path of the offset well, and the well path of the second offset well are superimposed over each other.

In some embodiments, in response to a determination that the offset well has been drilled at the wellsite, the well placement system determines an azimuth of the offset well. In one or more of such embodiments, the well placement system, in response to a determination that the azimuth of the offset well is not within a threshold range of an azimuth of the trajectory of the target well (e.g., within a 10° range, within a 25° range, or within another threshold range), projects a cross-section of the offset well where the cross-section has an azimuth that is within the threshold range of the azimuth of the trajectory of the target well.

In some embodiments, where there is no offset well at the wellsite, the well placement system determines whether an offset well of a nearby wellsite that is within a threshold distance (e.g., 1 mile radius, 5 miles radius, or another threshold distance) from the wellsite has been drilled at the nearby wellsite. In one or more of such embodiments, after the well placement system determines the presence of an offset well of a nearby wellsite, the well placement system then determines a well path of the offset well of the nearby wellsite and one or more parameters of the offset well of the nearby well. The well placement system then plots a well path of the offset well of the nearby wellsite, where the plot of the well path of the offset well of the nearby wellsite and the trajectory of the target well are superimposed over each other. Similarly, in some embodiments, the well placement system also performs the foregoing operations to determine well paths of additional offset wells as the nearby wellsite and plots the well paths of the additional offset wells on a plot, where the well paths of the offset wells of the nearby wellsite and the trajectory of the target well are superimposed over each other.

In some embodiments, the well placement system analyzes the well path of the offset well and the trajectory of the target well, and modifies a geological model of the target well based on the analysis of the well path of the offset well and the trajectory of the target well. In one or more of such embodiments, where the geological model of the target well includes the trajectory of the target well, the trajectory of the target well is adjusted to match or to have a similar well path as the well path of the offset well. In one or more of such embodiments, the geological model of the target well includes boundaries of a target zone that the trajectory of the target well passes through. In one or more of such embodiments, the boundaries of the target zone are also adjusted to match or to have similar boundaries as the boundaries of the offset well. In one or more of such embodiments, the geological model of the target well also illustrates or includes surfaces of the target zone that the trajectory of the target well passes through. In one or more of such embodiments, the well placement system also adjusts the locations and curvatures of the surfaces of the target zone the target well passes through based on the well path of the offset well. In some embodiments, the well placement system also estimates a dip angle of the target zone and adjusts the trajectory of the target well based on the dip angle of the target zone.

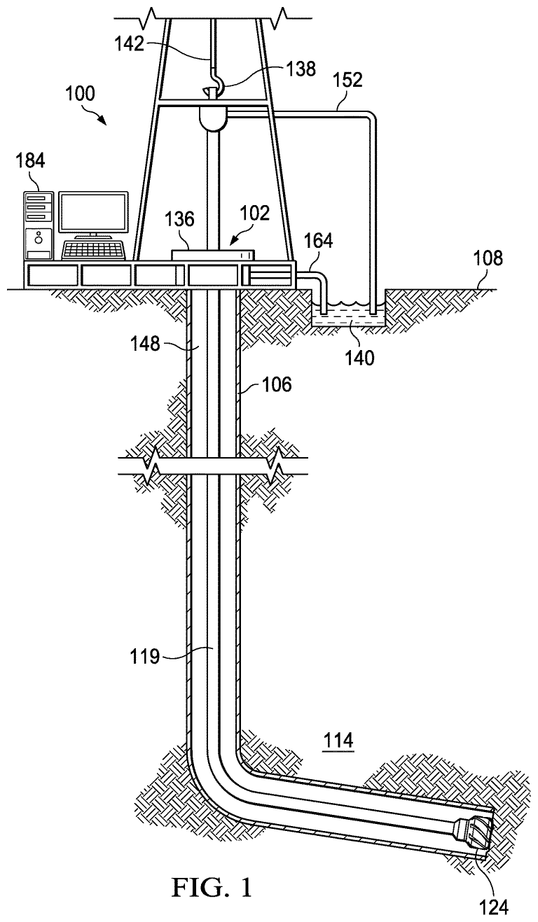

In some embodiments, operations described herein to determine well placement of a target well are performed before the target well is drilled. In some embodiments, operations described herein are also performed during the drill of the target well. In one or more of such embodiments, adjustments to the trajectory of the target well are made dynamically while the target well is drilled. Additional descriptions of the foregoing systems and methods to determine well placement are described in the paragraphs below and are illustrated in FIGS. 1-6.

Turning now to the figures, FIG. 1 is a schematic, side view of a drilling environment 100. In the embodiment of FIG. 1, a target well 102 having a wellbore 106 extends from a surface 108 of target well 102 to or through a formation 114. A hook 138, cable 142, traveling block (not shown), and hoist (not shown) are provided to lower a conveyance 119 down wellbore 106 of target well 102 or to lift conveyance 119 up from wellbore 106 of target well 102. In one or more embodiments, conveyance 119 may be a drill string, drill pipe, wireline, slickline, coiled tubing, production tubing, downhole tractor or another type of conveyance operable to be deployed in wellbore 106. At a wellhead 136, an inlet conduit 152 is coupled to a fluid source (not shown) to provide fluids, such as drilling fluids, downhole. In the embodiment of FIG. 1, conveyance 119 has an internal cavity that provides a fluid flow path from surface 108 to a downhole location.

In some embodiments, the fluids travel down conveyance 119 and exit conveyance 119 at a drill bit 124. The fluids flow back toward surface 108 through a wellbore annulus 148 and exit the wellbore annulus 148 via an outlet conduit 164 where the fluids are captured in container 140. In some embodiments, conveyance 119 also provides telemetry of data indicative of one or more parameters of the drilling operation and target well 102. Examples of parameters of the drilling operation and target well 102 include, but are not limited to, an azimuth of target well 102, a dip angle of target well 102, a frictional force experienced by conveyances and tools used during the drilling operation, the diameter of wellbore 106, the type of lubricity used for the drilling operation, presence of the cuttings bed in wellbore 106, presence of the pack-off, the dogleg in wellbore 106, the keyseat in wellbore 106, the degree of curvature of wellbore 106, the wellbore tortuosity of wellbore 106, the viscous effect of wellbore 106, the diameter of wellbore 106, the asperity between the conveyance used in the drilling operation and wellbore 106, as well as other parameters related to the drilling operation of target well 102.

In some embodiments, sensors or transducers (not shown) are located at the lower end of conveyance 119. In one or more embodiments, sensors are built into a cylindrical drill collar that is positioned close to drill bit 124. While drilling is in progress, these sensors continuously or intermittently determine one or more parameters of the drilling operation or target well 102, and transmit the information to a surface detector by one or more telemetry techniques including, but not limited to mud pulse telemetry, acoustic telemetry, and electromagnetic wave telemetry. In one or more embodiments, where a mud pulse telemetry system is deployed in wellbore 106 to provide telemetry, telemetry information is transmitted by adjusting the timing or frequency of viable pressure pulses in the drilling fluid that is circulated through conveyance 119 during drilling operations. In one or more embodiments, an acoustic telemetry system that transmits data via vibrations in the tubing wall of conveyance 119 is deployed in wellbore 106 to provide telemetry. More particularly, the vibrations are generated by an acoustic transmitter (not shown) mounted on conveyance 119 and propagate along conveyance 119 to an acoustic receiver (not shown) also mounted on conveyance 119. In one or more embodiments, an electromagnetic wave telemetry system that transmits data using current flows induced in conveyance 119 is deployed in wellbore 106 to provide telemetry. Additional types of telemetry systems may also be deployed in wellbore 106 to transmit data from tools (not shown) and other downhole components to well placement system 184.

In some embodiments, a surface-based electronic device, such as well placement system 184, includes one or more processors configured to generate a trajectory of a target well of a wellsite, plot the trajectory of the target well, and determine whether an offset well has been drilled at the wellsite. Further, in response to a determination that the offset well has been drilled at the wellsite, the one or more processors are further configured to determine a well path of the offset well and one or more parameters of the offset well, and plot a well path of the offset well, where the well path of the offset well and the trajectory of the target well are superimposed over each other. Additional descriptions of the processors and operations performed by the processors are described in the paragraphs below. Although FIG. 1 illustrates well placement system 184 as a surface-based electronic device that is located near target well 102, in some embodiments, well placement system 184 is located downhole or is located in another surface-based location remote from target well 102. In some embodiments, operations performed by well placement system 184 and described herein are performed prior to drilling of target well 102 or other wells (not shown). In some embodiments, some or all of the operations performed by well placement system 184 are performed during drilling operations to dynamically adjust the trajectory of target well 102.

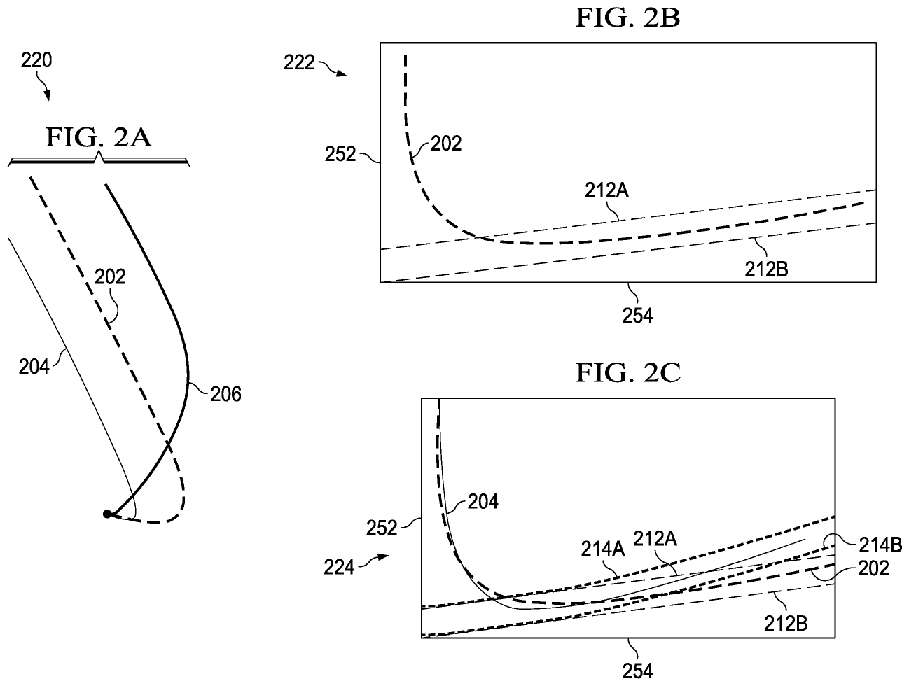

FIG. 2A is a plan view 220 of a trajectory of a target well and well paths and of two offset wells, where the trajectory of target well is represented by line 202, and the well paths of a first offset well and a second offset well are represented by lines 204 and 206, respectively. In the embodiment of FIG. 2A, target well 202 is drilled after the first offset well and the second offset well are drilled. Further, in the embodiment of FIG. 2A, the target well is drilled in between the first offset well and the second offset well. In some embodiments, a plan view similar to plan view 220 is generated by a well placement system, such as well placement system 184 of FIG. 1 before target well 202 is drilled. Although FIG. 2A illustrates two offset wells, in some embodiments, a different number of offset wells are utilized when performing the operations described herein to determine well placement of the target well.

FIG. 2B is a plot 222 of the trajectory of target well of FIG. 2A. In the embodiment of FIG. 2B, axis 252 represents the true vertical depth of a well, such as target well 202. Further, axis 254 represents the distance along a horizontal plane. Further, in the embodiment of FIG. 2B, lines 212A and 212B represent upper and lower boundaries of a target zone that the target well passes through. As shown in FIG. 2B, line 202, which represents the trajectory of the target well, passes through the upper and lower boundaries of the target zone.

FIG. 2C-2F are plots of the trajectory of target well of FIG. 2A and the well paths of one or more of first offset well and second offset well superimposed over each other. In the embodiments of FIGS. 2C-2F, axis 252 represents the true vertical depth of the one or more wells, and axis 254 represents the distance along a horizontal plane. In the embodiment of FIG. 2C, line 202, which represents the trajectory of the target well, and line 204, which represents the well path of the first offset well, are superimposed over each other. Further, lines 212A and 212B, which represent upper and lower boundaries of a target zone that the target well passes through, and lines 214A and 214B, which represent upper and lower boundaries of a zone that the first offset well passes through, are also superimposed over each other. FIG. 2D is a plot 226 of the trajectory of the target well and the well path of the second offset well superimposed over each other. In the embodiment of FIG. 2D, line 206, which represents the well path of the second offset well, and line 202 are superimposed over each other. Further, lines 212A and 212B, which represent upper and lower boundaries of a target zone that the target well passes through, and lines 216A and 216B, which represent upper and lower boundaries of a zone that the second offset well passes through, are superimposed over each other.

FIG. 2E is a plot of the trajectory of the target well, the well path of the first offset well illustrated in FIG. 2C, and the well path of the second offset well illustrated in FIG. 2D superimposed over each other. In the embodiment of FIG. 2E, lines 202, 204, and 206, which represent the trajectory of the target well, the well path of the first offset well, and the well path of the second offset well, respectively, are superimposed over each other. Further, lines 212A and 212B, 214A and 214B, and 216A and 216B, which represent upper and lower boundaries of a target zone that the target well passes through, the upper and lower boundaries of the zone the first offset well passes through, and the upper and lower boundaries of the zone the second offset well passes through, respectively, are superimposed over each other. FIG. 2F is another plot 230 of the trajectory of the target well, the well path of the first offset well illustrated in FIG. 2C, and the well path of the second offset well illustrated in FIG. 2D superimposed over each other. In the embodiment of FIG. 2F, lines representing the upper and lower boundaries of the target zones of the target well and the offset wells are not plotted. In some embodiments, a well placement system, such as well placement system 184 of FIG. 1, dynamically compares the superimposed plots of the trajectory of the target well and the well paths of one or more of the first offset well and the second offset well, and adjusts the trajectory of the target well to match or to have a similar trajectory as the well path of the offset wells. Similarly, in some embodiments, the well placement system also adjusts the boundaries of the target well to match or have similar boundaries (such as, but not limited to, similar shape, similar curvature, and dip angle) as the boundaries of the target zone of the offset wells. In one or more of such embodiments, the well placement system places a greater weight on one of the offset wells. For example, an offset well that is determined to have a more similar dip angle, drilled in the same formation, or is physically closer to the target well, is assigned a greater weight relative to another offset well that is determined to have a less similar dip angle, is drilled through a different formation, or is further away from the target well. In some embodiments, the trajectory of the target well and the upper and lower boundaries of the target zone of the target well are adjusted by an operator of the well path system. In some embodiments, offset wells at different wellsites are considered when determining well placement of the target well.

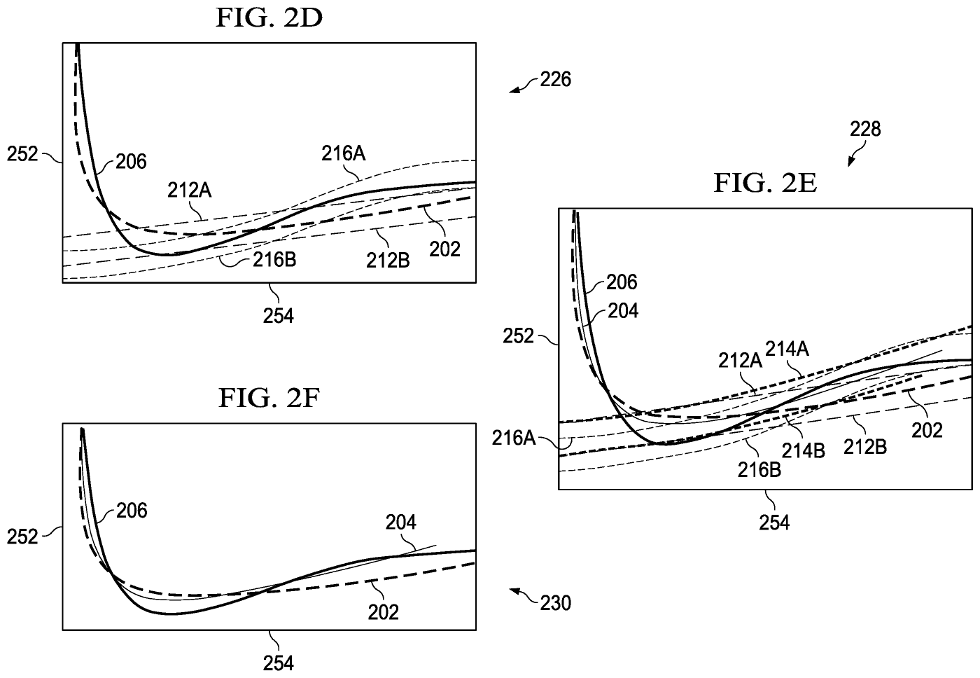

In that regard, FIG. 3A is a plan view of 320 a trajectory of a target well, and well paths of another well and two offset wells of a nearby wellsite, where the trajectory of target well is represented by line 302, and the well paths of a first offset well and a second offset well of the nearby wellsite are represented by lines 204 and 206, respectively. Further, line 202 represents the trajectory of another well of the nearby wellsite. In the embodiment of FIG. 3A, there is no offset well available at the wellsite of the target well. However, two target wells have already been drilled at a nearby wellsite. In some embodiments, where a target well is planned at a wellsite with no predrilled offsite well, the well paths of offset wells of a nearby wellsite are utilized to plan and modify the placement of the trajectory of the target well.

FIG. 3B is a plot 322 of the trajectory of the target well of FIG. 3A. In the embodiment of FIG. 3B, axis 352 represents the true vertical depth of a well, such as target well 302. Further, axis 354 represents the distance along a horizontal plane. Further, in the embodiment of FIG. 3B, lines 312A and 312B represent upper and lower boundaries of a target zone that the target well passes through. FIG. 3C is a plot 324 of the trajectory of the target well, the well path first offset well of the nearby wellsite, and the well path of the second offset well of the nearby wellsite superimposed over each other. In the embodiments of FIG. 3C, axis 352 represents the true vertical depth of the one or more wells, and axis 354 represents the distance along a horizontal plane. In the embodiment of FIG. 3C, line 302, which represents the trajectory of the target well, line 204, which represents the well path of the first offset well of the nearby wellsite, and line 206, which represents the well path of the second offset well of the nearby wellsite, are superimposed over each other. Further, lines 312A and 312B, which represent upper and lower boundaries of a target zone that the target well passes through, lines 214A and 214B, which represent upper and lower boundaries of a target zone that the first offset well of the nearby wellsite passes through, and lines 216A and 216B, which represent upper and lower boundaries of a target zone that the second offset well of the nearby wellsite passes through, are superimposed over each other.

In some embodiments, a well placement system, such as well placement system 184 of FIG. 1, dynamically compares the superimposed plots of the trajectory of the target well and the well paths of one or more offset wells of nearby wellsites, and adjusts the trajectory of the target well to match or to have a similar trajectory as the well path of the offset wells of the nearby wellsites. Similarly, in some embodiments, the well placement system also adjusts the boundaries of the target well to match or have similar boundaries (such as, but not limited to, similar shape, similar curvature, and dip angle) as the boundaries of the target zone of the offset wells of the nearby wellsites. In some embodiments, one or more offset wells of a nearby wellsite are selected and are utilized to plan and modify the trajectory of a target well even when there is at least one offset well at the wellsite of the target well. In some embodiments, the well placement system selects multiple offset wells from multiple nearby wellsites. In one or more of such embodiments, the well placements system utilizes a weighted system when determining which offset well is selected. For example, an offset well that is determined to have a more similar dip angle, drilled in the same formation, or is physically closer to the target well is assigned a greater weight relative to another offset well that is determined to have a less similar dip angle, is drilled through a different formation, or is further away from the target well. In some embodiments, the trajectory of the target well and the upper and lower boundaries of the target zone of the target well are adjusted by an operator of the well path system.

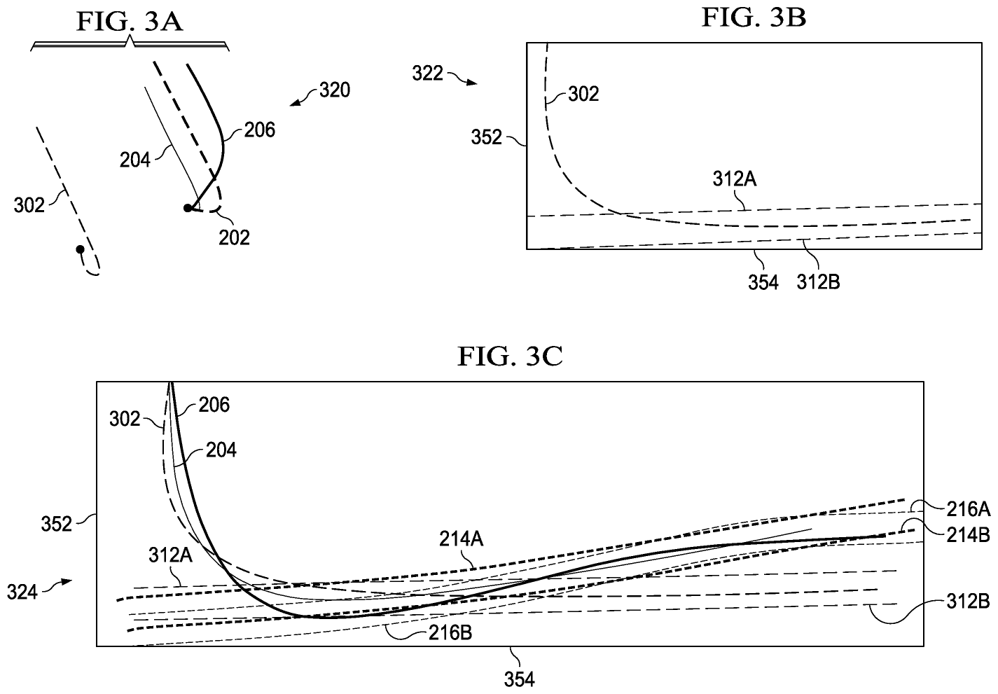

FIG. 4 is a plan view of a trajectory of a target well and a well path of an offset well having an azimuth that is not within a threshold range of an azimuth of the target well. In the embodiment of FIG. 4, line 402 represents a trajectory of the target well. Further, line 404 represents the well path of an offset well. In the embodiment of FIG. 4, the azimuth of the target well and the azimuth of the offset well are not within a threshold range (e.g., 15°, 25°, 45°, or another threshold number of degrees) of each other. For example, where the trajectory of the target well has an azimuth of 330°, and the well path of the target well has a trajectory of 300°, the well path of the offset well would not have an azimuth that is within a threshold range of the azimuth of the target well if the threshold range is less than or equal to 15°. In some embodiments, a cross-section of the offset well having an azimuth that is within the threshold range of the trajectory of the target well is projected and is superimposed with the trajectory of the target well. In that regard, line 424 represents a projected cross-section of the offset well, where the projected cross-section has an azimuth that is within the threshold range of the azimuth of the trajectory of the target well. In the embodiment of FIG. 4, the azimuth of the projected cross-section of the offset well and the azimuth of the target well are approximately identical. In some embodiments, the azimuth of the projected cross-section of the offset well and the azimuth of the target well are not identical but are still within the threshold range (e.g., less than or equal to 15°, less than or equal to 30°, or less than or equal to another threshold value). In some embodiments, the projected cross-section of the offset well is utilized to determine and modify the trajectory of the target well.

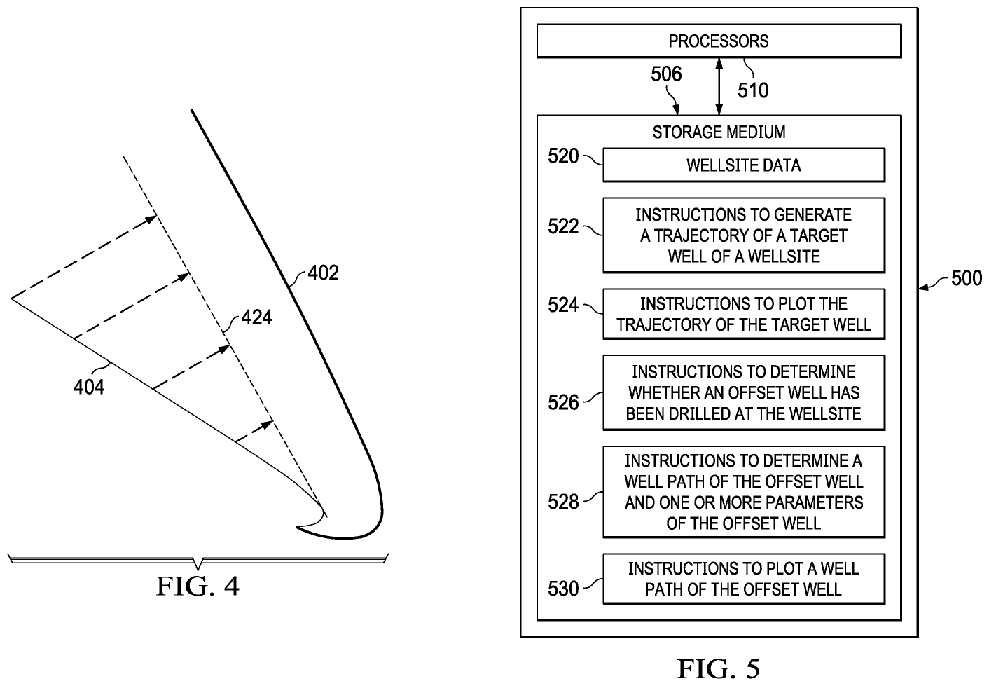

FIG. 5 is a block diagram of a well placement system 500. Well placement system 500 includes a storage medium 506 and processors 510. Storage medium 506 may be formed from data storage components such as, but not limited to, read-only memory (ROM), random access memory (RAM), flash memory, magnetic hard drives, solid-state hard drives, CD-ROM drives, DVD drives, floppy disk drives, as well as other types of data storage components and devices. In some embodiments, storage medium 506 includes multiple data storage devices. In further embodiments, the multiple data storage devices may be physically stored at different locations. Wellsite data are stored at a first location 520 of storage medium 506. As shown in FIG. 5, instructions to generate a trajectory of a target well of a wellsite are stored at a second location 522 of storage medium 506, instructions to plot the trajectory of the target well are stored at a third location 524 of the storage medium 506, instructions to determine whether an offset well has been drilled at the wellsite are stored at a fourth location 526 of storage medium 506, instructions to determine a well path of the offset well and one or more parameters of the offset well are stored at a fifth location 528 of storage medium 506, and instructions to plot a well path of the offset well are stored at a sixth location 530 of storage medium 506. The instructions to perform other operations described herein are also stored in the storage medium 506.

Well placement system 500 is also configured to analyze the trajectory of the target well and the well paths of one or more offset wells, and modify the trajectory of the target well based on the well paths of the offset wells. In some embodiments, well placement system 500 is also configured to modify a geological model of the target well. In one or more of such embodiments, well placement system 500 adjusts the trajectory of the target well and the boundaries of the target zone that the target well passes through based on the well paths of one or more offset wells and the boundaries of the target zones of the one or more offset wells. In one or more of such embodiments, well placement system 500 determines and adjusts the dip angle of the target well based on the dip angles of one or more offset wells.

In some embodiments, well placement system 500 is a component of well placement system 184 of FIG. 1, or a component of another surface-based electronic device. In some embodiments, well placement system 500 is formed from well placement system 184 of FIG. 1, or from other surface-based electronic devices. In further embodiments, well placement system 500 is a component of a downhole tool that is deployed in wellbore 106 of FIG. 1. In further embodiments, parts of well placement system 500 are deployed on a surface-based electronic device, such as well placement system 184 of FIG. 1, and parts of well placement system 500 are deployed downhole.

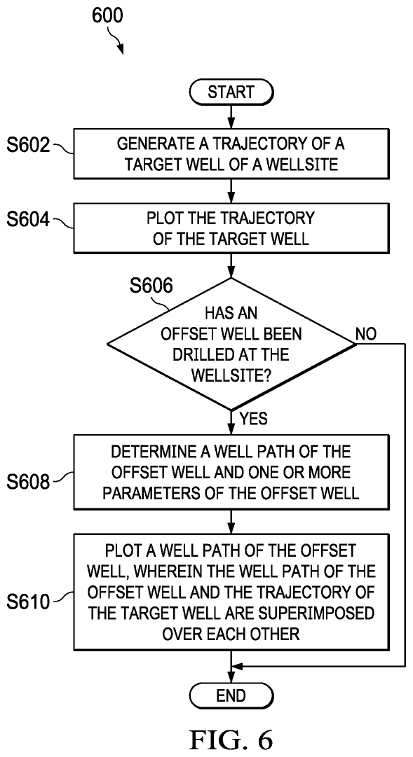

FIG. 6 is a flow chart of a process 600 to determine well placement. Although the operations in the process 600 are shown in a particular sequence, certain operations may be performed in different sequences or at the same time where feasible. Further, although the operations in process 600 are described to be performed by processors 510 of well placement system 500 of FIG. 5, the operations may also be performed by one or more processors of other electronic devices operable to perform operations described herein.

As described below, process 600 provides an intuitive way for determining well placements, such as determining the well placement of well 102 in the environment of FIG. 1. The process provides real time or near real time analysis of the trajectory of a target well relative to the well paths of pre-drilled offset wells. In some embodiments, the process also dynamically compares the trajectory of the target well with the well paths of one or more nearby offset wells.

In some embodiments, the process also dynamically matches, recommends modifications to, or modifies the trajectory of the target well based on the well paths of the one or more offset wells, thereby allowing an operator to make informed real time or near real time adjustments to the trajectory of the target well.

At block S602, a trajectory of a target well of a wellsite is generated. At block S604, the trajectory of the target well is plotted. FIG. 2B, for example illustrates a plot of the target well where the trajectory of a target well is represented by line 202 and the upper and lower boundaries of the target zone of the target well are represented by lines 212A and 212B, respectively. At block S606, a determination of whether an offset well has been drilled at the wellsite is made. At block S608, in response to a determination that an offset well has been drilled at the wellsite, a well path and one or more parameters of the offset well are determined. At block S610, the well path of the offset well is plotted, where the well path of the offset well and the trajectory of the target well are superimposed over each other. FIG. 2C, for example, illustrates a plot 224, where the trajectory of the target well as represented by line 202 and the well path of the first offset well of the wellsite as represented by line 204 are plotted together and are superimposed over each other. In some embodiments, only offset wells within a threshold distance of the location of the target well are considered. In some embodiments only offset wells drilled within a threshold period of time (e.g., within the last month, within the last year, or within another threshold period of time) are considered.

In some embodiments, a determination of whether a second offset well has been drilled at the wellsite is made. In one or more of such embodiments, and in response to a determination that a second offset well has been drilled at the wellsite, a well path and one or more parameters of the second offset well are determined. Further, the well path of the second offset well is plotted, where the trajectory of the target well, and the well paths of the first and second offset wells are superimposed over each other. FIG. 2E, for example, illustrates a plot 228, where the trajectory of the target well as represented by line 202 and the well paths of the first offset well of the wellsite and the second offset well of the wellsite as represented by lines 204 and 206, respectively, are superimposed over each other. In some embodiments, a determination of one or more characteristics of the offset well is made. Examples of characteristics of the offset well include, but are not limited to, the azimuth of the offset well, the type of formation the offset well is drilled in, the location of the offset well relative to the location of the target well, the distance of the offset well from the target well, the length of the offset well, the curvature of the offset well, as well as other quantifiable characteristics of the offset well. In some embodiments, only offset wells having certain characteristics (e.g., sharing the same or having an azimuth that is within a threshold range of the azimuth of the target well, drilled in the same type of formation, having a length that is identical or within a range (e.g., 100 feet, 500 feet, or another threshold range) of the intended length of the target well, or other types of quantifiable characteristics) are considered and are plotted with the target well. In one or more of such embodiments, a determination of the azimuth of the offset well is made. Further, in response to a determination that the azimuth of the offset well is not within a threshold range of an azimuth of the trajectory of the target well, a cross-section of the offset well having an azimuth that is within the threshold range of the azimuth of the trajectory of the target well is made, the well path and one or more characteristics of the cross-section of the offset well are determined, and the cross-section of the offset well is plotted with the trajectory of the target well. In that regard, FIG. 4, for example, illustrates generating a projection of a cross-section of an offset well, where the cross-section is represented by line 424, and plotting line 424 with the trajectory of the target well, which is represented by line 402.

In the embodiment illustrated in FIG. 6, the process ends if no offset well has been drilled at the wellsite. In some embodiments, where no offset well has been drilled at the wellsite of the target well, a determination of whether an offset well of a nearby wellsite that is within a threshold distance from the wellsite is made. Further, in response to a determination that an offset well of a nearby wellsite has been drilled, a well path of the offset well and parameters of the offset well of the nearby wellsite are determined, and the well path of the offset well of the nearby wellsite is plotted with the trajectory of the target well. FIG. 3C, for example, illustrates plots of well paths of two offset wells located at a nearby wellsite as represented by lines 204 and 206, and the trajectory of the target well as represented by line 302.

In some embodiments, the well paths of the offset well and the trajectory of the target well are analyzed and a geological model of the target well is modified based on an analysis of the well path of the offset well and the trajectory of the target well. In one or more of such embodiments, the trajectory of the target well and the target zone that the trajectory of the target well passes through are adjusted based on the well path of the offset well and the target zone that the offset well passes through. In one or more of such embodiments, the trajectory of the target well is modified to match the well path of the offset well. In one or more of such embodiments, the locations of surfaces of the target zone of the target well passes through are also adjusted based on corresponding locations of surfaces of target zones of the offset well. In some embodiments, the dip angle of a target zone of the target well is estimated, and the trajectory of the target well is adjusted based on the dip angle of the target zone. In some embodiments, where the well paths of multiple offset wells are considered, different offset wells are assigned different weight based on one or more characteristics of the offset well. For example, an offset well that is drilled in the same formation as the target well and is located within 100 feet of the target well is assigned greater weight than a second offset well that is drilled in a different formation and is located 500 feet from the target well. In some embodiments, the adjustments described herein are made dynamically, such as by well planning system 184 and 500 of FIGS. 1 and 5 while the target well is being drilled. In some embodiments, plots of the trajectory of the target well and one or more offset wells are provided for display to an operator and adjustments to the trajectory of the target well and the geological model of the target well are manually made by the operator. In some embodiments, proposed adjustments to the trajectory of the target well and modifications to the geological model of the target well are determined and are proposed to an operator, and are made if the proposed adjustments and modifications are not rejected within a threshold period of time.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/processes may be performed in parallel or out of sequence, or combined into a single step/process. The scope of the claims is intended to broadly cover the disclosed embodiments and any such modification. Further, the following clauses represent additional embodiments of the disclosure and should be considered within the scope of the disclosure.

Clause 1, a method to determine well placement, comprising: generating a trajectory of a target well of a wellsite; plotting the trajectory of the target well, determining whether an offset well has been drilled at the wellsite; and in response to a determination that the offset well has been drilled at the wellsite: determining a well path of the offset well and one or more parameters of the offset well; and plotting the well path of the offset well, wherein the well path of the offset well and the trajectory of the target well are superimposed over each other.

Clause 2, the method of clause 1, further comprising: determining whether a second offset well has been drilled at the wellsite; in response to a determination that the second offset well has been drilled at the wellsite: determining a well path of the second offset well and one or more parameters of the offset well; and plotting the well path of the second offset well, wherein the trajectory of the target well, the well path of the offset well, and the well path of the second offset well are superimposed over each other.

Clause 3, the method of clause 2, wherein the trajectory of the target well runs in between the offset well and the second offset well.

Clause 4, the method of any of clauses 1-3, further comprising: in response to a determination that the offset well has been drilled at the wellsite: determining an azimuth of the offset well; and in response to a determination that the azimuth of the offset well is not within a threshold range of an azimuth of the trajectory of the target well: projecting a cross-section of the offset well having an azimuth that is within the threshold range of the azimuth of the trajectory of the target well, wherein determining the well path of the offset well and one or more parameters of the offset well comprises determining a well path of the cross-section of the well path of the offset well and one or more parameters of the cross-section of the offset well, and wherein plotting the well path of the offset well comprises plotting the well path of the cross-section of the offset well.

Clause 5, the method of any of clauses 1-4, wherein the offset well of the wellsite has an azimuth that is within a threshold range of an azimuth of the trajectory of a target well.

Clause 6, the method of any of clauses 1-5, further comprising: in response to a determination that no offset well has been drilled at the wellsite; determining whether an offset well of a nearby wellsite that is within a threshold distance from the wellsite has been drilled at the nearby wellsite; and in response to a determination that an offset well of a nearby wellsite has been drilled: determining a well path of the offset well of the nearby wellsite and one or more parameters of the offset well of the nearby wellsite; and plotting the well path of the offset well of the nearby wellsite, wherein the well path of the offset well of the nearby wellsite and the trajectory of the target well are superimposed over each other.

Clause 7, the method of clause 6, further comprising: in response to a determination that the offset well of the nearby wellsite has been drilled: determining an azimuth of the offset well of the nearby wellsite; and in response to a determination that the azimuth of the offset well of the nearby wellsite is not within a threshold range of an azimuth of the trajectory of the target well: projecting a cross-section of the offset well of the nearby wellsite having an azimuth that is within the threshold range of the azimuth of the trajectory of the target well, wherein determining the well path of the offset well of the nearby wellsite and one or more parameters of the offset well of the nearby wellsite comprises determining the well path of the cross-section of the offset well of the nearby wellsite and one or more parameters of the cross-section of the offset well of the nearby wellsite, and wherein plotting the well path of the offset well of the nearby wellsite comprises plotting the well path of the cross-section of the offset well of the nearby wellsite.

Clause 8, the method of clauses 6 or 7, further comprising: determining whether a second offset of the nearby wellsite well has been drilled at the nearby wellsite; in response to a determination that the second offset well of the nearby wellsite has been drilled: determining a well path of the second offset well of the nearby wellsite and one or more parameters of the offset well of the nearby wellsite; and plotting the well path of the second offset well of the nearby wellsite, wherein the trajectory of the target well, the well path of the offset well of the nearby wellsite, and the well path of the second offset well of the nearby wellsite are superimposed over each other.

Clause 9, the method of any of clauses 1-7, further comprising: analyzing the well path of the offset well and the trajectory of the target well; and modifying a geological model of the target well.

Clause 10, the method of clause 9, wherein modifying the geological model of the target well comprises adjusting the trajectory of the target well and a target zone that the trajectory of the target well passes through.

Clause 11, the method of clause 10, wherein modifying the geological model of the target well further comprises adjusting one or more boundaries of the target zone the trajectory of the target well passes through.

Clause 12, the method of any of clauses 9-11, further comprising: estimating a dip angle of a target zone that the trajectory of the target well passes through; and adjusting the trajectory of the target well based on the dip angle of the target zone.

Clause 13, the method of any of clauses 9-12, wherein the trajectory of the target well is adjusted during drilling of the target well.

Clause 14, a system to determine well placement, comprising: a storage medium; and one or more processors configured to: generate a trajectory of a target well of a wellsite; plot the trajectory of the target well, determine whether an offset well has been drilled at the wellsite; and in response to a determination that the offset well has been drilled at the wellsite: determine a well path of the offset well and one or more parameters of the offset well; and plot the well path of the offset well, wherein the well path of the offset well and the trajectory of the target well are superimposed over each other.

Clause 15, the system of clause 14, wherein the one or more processors are further configured to: determine whether a second offset well has been drilled at the wellsite; in response to a determination that the second offset well has been drilled at the wellsite: determine a well path of the second offset well and one or more parameters of the offset well; and plot the well path of the second offset well, wherein the trajectory of the target well, the well path of the offset well, and the well path of the second offset well are superimposed over each other.

Clause 16, the system of clauses 14 or 15, wherein the one or more processors are further configured to: in response to a determination that the offset well has been drilled at the wellsite: determine an azimuth of the offset well; and in response to a determination that the azimuth of the offset well is not within a threshold range of an azimuth of the trajectory of the target well: project a cross-section of the offset well having an azimuth that is within the threshold range of the azimuth of the trajectory of the target well, wherein determining the well path of the offset well and one or more parameters of the offset well comprises determining a well path of the cross-section of the well path of the offset well and one or more parameters of the cross-section of the offset well, and wherein plotting the well path of the offset well comprises plotting the well path of the cross-section of the offset well.

Clause 17, the system of any of clauses 14-16, wherein the one or more processors are further configured to: in response to a determination that no offset well has been drilled at the wellsite; determine whether an offset well of a nearby wellsite that is within a threshold distance from the wellsite has been drilled at the nearby wellsite; and in response to a determination that an offset well of a nearby wellsite has been drilled: determine a well path of the offset well of the nearby wellsite and one or more parameters of the offset well of the nearby wellsite; and plot the well path of the offset well of the nearby wellsite, wherein the well path of the offset well of the nearby wellsite and the trajectory of the target well are superimposed over each other.

Clause 18, a non-transitory machine-readable medium comprising instructions stored therein which, when executed by a processor, cause the processor to perform operations comprising: generating a trajectory of a target well of a wellsite; plotting the trajectory of the target well, determining whether an offset well has been drilled at the wellsite; in response to a determination that the offset well has been drilled at the wellsite: determining a well path of the offset well and one or more parameters of the offset well; and plotting the well path of the offset well; determining whether a second offset well has been drilled at the wellsite; and in response to a determination that the second offset well has been drilled at the wellsite: determining a well path of the second offset well and one or more parameters of the offset well; and plotting the well path of the second offset well, wherein the trajectory of the target well, the well path of the offset well, and the well path of the second offset well are superimposed over each other.

Clause 19, the non-transitory machine-readable medium of clause 18, wherein the instructions which, when executed by the processor, cause the processor to perform operations comprising: in response to a determination that no offset well has been drilled at the wellsite; determining whether an offset well of a nearby wellsite that is within a threshold distance from the wellsite has been drilled at the nearby wellsite; and in response to a determination that an offset well of a nearby wellsite has been drilled: determining a well path of the offset well of the nearby wellsite and one or more parameters of the offset well of the nearby wellsite; and plotting the well path of the offset well of the nearby wellsite, wherein the well path of the offset well of the nearby wellsite and the trajectory of the target well are superimposed over each other.

Clause 20, the non-transitory machine-readable medium of clauses 18 or 19, wherein the instructions which, when executed by the processor, cause the processor to perform operations comprising: analyzing the well path of the offset well and the trajectory of the target well; and modifying a geological model of the target well.

As used herein, the singular forms “a,” “an,” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

What is claimed is:

1. A method to determine well placement, comprising:
generating a trajectory of a target well of a wellsite;
plotting the trajectory of the target well,
determining whether an offset well has been drilled at the wellsite; and
in response to a determination that the offset well has been drilled at the wellsite:
determining a well path of the offset well and one or more parameters of the offset well; and
plotting the well path of the offset well, wherein the well path of the offset well and the trajectory of the target well are superimposed over each other.

2. The method of claim 1, further comprising:
determining whether a second offset well has been drilled at the wellsite;
in response to a determination that the second offset well has been drilled at the wellsite:
determining a well path of the second offset well and one or more parameters of the offset well; and
plotting the well path of the second offset well, wherein the trajectory of the target well, the well path of the offset well, and the well path of the second offset well are superimposed over each other.

3. The method of claim 2, wherein the trajectory of the target well runs in between the offset well and the second offset well.

4. The method of claim 1, further comprising:
in response to a determination that the offset well has been drilled at the wellsite:
determining an azimuth of the offset well; and
in response to a determination that the azimuth of the offset well is not within a threshold range of an azimuth of the trajectory of the target well:
projecting a cross-section of the offset well having an azimuth that is within the threshold range of the azimuth of the trajectory of the target well,
wherein determining the well path of the offset well and one or more parameters of the offset well comprises determining a well path of the cross-section of the well path of the offset well and one or more parameters of the cross-section of the offset well, and
wherein plotting the well path of the offset well comprises plotting the well path of the cross-section of the offset well.

5. The method of claim 1, wherein the offset well of the wellsite has an azimuth that is within a threshold range of an azimuth of the trajectory of a target well.

6. The method of claim 1, further comprising:
in response to a determination that no offset well has been drilled at the wellsite;
determining whether an offset well of a nearby wellsite that is within a threshold distance from the wellsite has been drilled at the nearby wellsite; and
in response to a determination that an offset well of a nearby wellsite has been drilled:
determining a well path of the offset well of the nearby wellsite and one or more parameters of the offset well of the nearby wellsite; and
plotting the well path of the offset well of the nearby wellsite, wherein the well path of the offset well of the nearby wellsite and the trajectory of the target well are superimposed over each other.

7. The method of claim 6, further comprising:
in response to a determination that the offset well of the nearby wellsite has been drilled:
determining an azimuth of the offset well of the nearby wellsite; and
in response to a determination that the azimuth of the offset well of the nearby wellsite is not within a threshold range of an azimuth of the trajectory of the target well:
projecting a cross-section of the offset well of the nearby wellsite having an azimuth that is within the threshold range of the azimuth of the trajectory of the target well,
wherein determining the well path of the offset well of the nearby wellsite and one or more parameters of the offset well of the nearby wellsite comprises determining the well path of the cross-section of the offset well of the nearby wellsite and one or more parameters of the cross-section of the offset well of the nearby wellsite, and
wherein plotting the well path of the offset well of the nearby wellsite comprises plotting the well path of the cross-section of the offset well of the nearby wellsite.

8. The method of claim 6, further comprising:
determining whether a second offset of the nearby wellsite well has been drilled at the nearby wellsite;
in response to a determination that the second offset well of the nearby wellsite has been drilled:
determining a well path of the second offset well of the nearby wellsite and one or more parameters of the offset well of the nearby wellsite; and
plotting the well path of the second offset well of the nearby wellsite, wherein the trajectory of the target well, the well path of the offset well of the nearby wellsite, and the well path of the second offset well of the nearby wellsite are superimposed over each other.

9. The method of claim 1, further comprising:
analyzing the well path of the offset well and the trajectory of the target well; and
modifying a geological model of the target well.

10. The method of claim 9, wherein modifying the geological model of the target well comprises adjusting the trajectory of the target well and a target zone that the trajectory of the target well passes through.

11. The method of claim 10, wherein modifying the geological model of the target well further comprises adjusting one or more boundaries of the target zone the trajectory of the target well passes through.

12. The method of claim 9, further comprising:
estimating a dip angle of a target zone that the trajectory of the target well passes through; and
adjusting the trajectory of the target well based on the dip angle of the target zone.

13. The method of claim 9, wherein the trajectory of the target well is adjusted during drilling of the target well.

14. A system to determine well placement, comprising:
a storage medium; and
one or more processors configured to:
generate a trajectory of a target well of a wellsite;
plot the trajectory of the target well,
determine whether an offset well has been drilled at the wellsite; and
in response to a determination that the offset well has been drilled at the wellsite:
determine a well path of the offset well and one or more parameters of the offset well; and
plot the well path of the offset well, wherein the well path of the offset well and the trajectory of the target well are superimposed over each other.

15. The system of claim 14, wherein the one or more processors are further configured to:
determine whether a second offset well has been drilled at the wellsite;
in response to a determination that the second offset well has been drilled at the wellsite:
determine a well path of the second offset well and one or more parameters of the offset well; and
plot the well path of the second offset well, wherein the trajectory of the target well, the well path of the offset well, and the well path of the second offset well are superimposed over each other.

16. The system of claim 14, wherein the one or more processors are further configured to:
in response to a determination that the offset well has been drilled at the wellsite:
determine an azimuth of the offset well; and
in response to a determination that the azimuth of the offset well is not within a threshold range of an azimuth of the trajectory of the target well:
project a cross-section of the offset well having an azimuth that is within the threshold range of the azimuth of the trajectory of the target well,
wherein determining the well path of the offset well and one or more parameters of the offset well comprises determining a well path of the cross-section of the well path of the offset well and one or more parameters of the cross-section of the offset well, and
wherein plotting the well path of the offset well comprises plotting the well path of the cross-section of the offset well.

17. The system of claim 14, wherein the one or more processors are further configured to:
in response to a determination that no offset well has been drilled at the wellsite;
determine whether an offset well of a nearby wellsite that is within a threshold distance from the wellsite has been drilled at the nearby wellsite; and
in response to a determination that an offset well of a nearby wellsite has been drilled:
determine a well path of the offset well of the nearby wellsite and one or more parameters of the offset well of the nearby wellsite; and
plot the well path of the offset well of the nearby wellsite, wherein the well path of the offset well of the nearby wellsite and the trajectory of the target well are superimposed over each other.

18. A non-transitory machine-readable medium comprising instructions stored therein which, when executed by a processor, cause the processor to perform operations comprising:
generating a trajectory of a target well of a wellsite;
plotting the trajectory of the target well,
determining whether an offset well has been drilled at the wellsite;
in response to a determination that the offset well has been drilled at the wellsite:
determining a well path of the offset well and one or more parameters of the offset well; and
plotting the well path of the offset well;
determining whether a second offset well has been drilled at the wellsite; and
in response to a determination that the second offset well has been drilled at the wellsite:
determining a well path of the second offset well and one or more parameters of the offset well; and
plotting the well path of the second offset well, wherein the trajectory of the target well, the well path of the offset well, and the well path of the second offset well are superimposed over each other.

19. The non-transitory machine-readable medium of claim 18, wherein the instructions which, when executed by the processor, cause the processor to perform operations comprising:
in response to a determination that no offset well has been drilled at the wellsite;
determining whether an offset well of a nearby wellsite that is within a threshold distance from the wellsite has been drilled at the nearby wellsite; and
in response to a determination that an offset well of a nearby wellsite has been drilled:
determining a well path of the offset well of the nearby wellsite and one or more parameters of the offset well of the nearby wellsite; and
plotting the well path of the offset well of the nearby wellsite, wherein the well path of the offset well of the nearby wellsite and the trajectory of the target well are superimposed over each other.

20. The non-transitory machine-readable medium of claim 18, wherein the instructions which, when executed by the processor, cause the processor to perform operations comprising:
analyzing the well path of the offset well and the trajectory of the target well; and
modifying a geological model of the target well.
